(19) United States
(12) Patent Application Publication
(10) Pub. No.: US 2010/0266481 A1
(43) Pub. Date: Oct. 21, 2010

(54) PROCESSES FOR THE OXIDATION OF A GAS CONTAINING HYDROGEN CHLORIDE

(75) Inventors: Michel Haas, Dormagen (DE); Markus Dugal, Kempen (DE); Knud Werner, Krefeld (DE)

Correspondence Address: CONNOLLY BOVE LODGE & HUTZ, LLP, P O BOX 2207, WILMINGTON, DE, 19899, US

(73) Assignee: Bayer Material Science AG, Leverkusen (DE)

(21) Appl. No.: 11/752,374

(22) Filed: May 23, 2007

(30) Foreign Application Priority Data
May 23, 2006 (DE) 102006024548.2

(51) Int. Cl. C01B 7/04

(52) U.S. Cl. 423/502

(57) ABSTRACT

Processes for the production of chlorine from a gas containing hydrogen chloride and carbon monoxide, which comprise the catalysed oxidation of the carbon monoxide as well as optionally further oxidizable constituents, with oxygen to form carbon dioxide in an upstream reactor under adiabatic conditions.

### BACKGROUND OF THE INVENTION

A large number of chemical processes involving reactions with chlorine or phosgene, such as the production of isocyanates or chlorinations of aromatic compounds, lead to the formation of hydrogen chloride. The hydrogen chloride can be converted back into chlorine by electrolysis. Compared to this very energy-intensive method, the direct oxidation of hydrogen chloride with pure oxygen or with an oxygen-containing gas on heterogeneous catalysts (the so-called Deacon process) according to the equation

4 HCl+O₂ [symbol] 2 Cl₂+2 H₂O

provides significant advantages as regards the energy consumption.

With most processes such as phosgenation, a relatively large amount of carbon monoxide (CO) may be contained as impurity in the HCl waste gas. In the generally widely used liquid phase phosgenation reactions, carbon monoxide in an amount from 0 to 3 vol. % can be found in the HCl waste gas from the phosgene scrubbing column. In state-of-the-art gaseous phase phosgenations, even higher CO amounts (up to more than 5%) can be expected, since in such methods preferably no condensation of phosgene, and therefore no associated large scale separation of the unreacted carbon monoxide, is carried out before the phosgenation.

In the conventional catalytic oxidation of hydrogen chloride with oxygen, a very wide range of catalysts can be employed, e.g., based on ruthenium, chromium, copper, etc. Such catalysts are described, for example, in DE1567788 A1, EP251731A2, EP936184A2, EP761593A1, EP711599A1 and DE10250131A1, the entire contents of each of which are herein incorporated by reference. Such catalysts can however at the same time act as oxidation catalysts for other components that may be present in a reaction stream, such as carbon monoxide or various organic compounds. The catalytic carbon monoxide oxidation to carbon dioxide is however extremely exothermic and can cause uncontrolled local temperature rises (hot spots) at the surface of heterogeneous catalysts, with the result that a deactivation of the catalyst with respect to the HCl oxidation may occur. For example, without cooling under adiabatic conditions, the oxidation of 5% carbon monoxide in an inert gas (e.g., N₂) at an inflow temperature of 250° C. (described operating temperatures in Deacon processes are generally 200°-450° C.) would result in a temperature rise of far above 200° C. One likely reason for the catalyst deactivation may be microstructural change of the catalyst surface, e.g., by sintering processes, on account of the formation of hot spots.

Furthermore the adsorption of carbon monoxide on the surface of the catalyst cannot be excluded. The formation of metal carbonyls may take place reversibly or irreversibly and may thus occur in direct competition to the desired HCl oxidation. Carbon monoxide can, at high temperatures, form very stable bonds with some elements, such as, e.g., osmium, rhenium, ruthenium (see, e.g., CHEM. REV. 103, 3707-3732, 2003), and may thereby inhibit the desired target reaction. A further disadvantage could arise due to the volatility of such metal carbonyls (see, e.g., CHEM. REV. 21, 3-38, 1937), whereby not inconsiderable amounts of catalyst are lost and in addition, depending on the application, an expensive and complicated purification step of the reaction product can be necessary.

Also, in the Deacon process a catalyst deactivation can be caused by destruction of the catalysts as well as by lowering the stability. A competition between hydrogen chloride and carbon monoxide may also lead to an inhibition of the desired HCl oxidation reaction. For an optimal operation of the Deacon process, as low a content of carbon monoxide as possible in the HCl gas is accordingly desirable in order to lengthen the service life of the employed catalyst.

Attempts to avoid such problems have been described which include carrying out an oxidation of CO in the HCl stream in a serially upstream-connected reactor based on known catalysts where the gaseous mixture is led, in the presence of oxygen, isothermally at elevated temperature over a supported ruthenium or palladium catalyst.

The operating temperatures of such catalysts are greatly in excess of room temperature, and are normally above 300° C. The processes are carried out isothermally. Disadvantages of these processes are, on the one hand, that the avoidance of hot spots is not guaranteed, and complicated equipment is necessary in order to remove heat. Second, the conditions in such processes do not always lead to a selective oxidation of CO, but rather partial oxidation of HCl to chlorine also takes place. Furthermore, the feed gases must be strongly heated externally before they are passed to the catalyst.

Other alternative approaches attempt to stabilize the catalytic phase for the HCl oxidation so as to allow the simultaneous oxidation of hydrogen chloride and carbon monoxide, as well as further subsidiary constituents, (e.g., phosgene, hydrogen and organic compounds). This procedure is however limited to minor amounts of subsidiary constituents, preferably below 0.5 vol. % in the HCl gas stream.

In the described Deacon or Deacon-like processes, for the efficient execution of the catalytic HCl oxidation the HCl gas must be preheated by external addition of energy, e.g., via heat exchangers in front of the reactor inlet, from an initial temperature in the range from about −10° to 60° C. to a temperature in the range from 150° to 350° C. This leads to an increase in the energy and investment costs of a technical plant.

### BRIEF SUMMARY OF THE INVENTION

One object of the present invention is accordingly to provide a process that is as efficient as possible, i.e., in particular energy-saving as well as cost-effective, for the oxidation of carbon monoxide to carbon dioxide in an HCl-containing gas that is subsequently to be fed to a Deacon process or Deacon-like process for the oxidation of the hydrogen chloride with oxygen.

The present invention relates, generally, to processes for the production of chlorine from a gas containing hydrogen chloride and carbon monoxide, which processes include the catalyzed oxidation of the carbon monoxide, as well as optionally further oxidizable constituents, with oxygen to form carbon dioxide in an upstream-connected reactor under adiabatic conditions.

One embodiment of the present invention thus relates to a process for the production of chlorine from a gas containing hydrogen chloride and carbon monoxide, which comprises: (a) catalytic oxidation of the carbon monoxide, as well as possibly further oxidizable constituents, with oxygen to form an intermediate gas comprising hydrogen chloride and carbon dioxide in an upstream-connected reactor under adiabatic conditions; and (b) catalytic oxidation of the hydrogen chloride in the intermediate gas with oxygen to form chlorine.

### BRIEF DESCRIPTION OF THE SEVERAL VIEWS OF THE DRAWINGS

The foregoing summary, as well as the following detailed description of the invention, will be better understood when read in conjunction with the appended drawings. For the purpose of illustrating the invention, there are shown in the drawings embodiments which are presently preferred. It should be understood, however, that the invention is not limited to the precise arrangements and instrumentalities shown.

In the drawings:

FIG. 1 is a graphical representation of the relationship between CO content and outflow temperature resulting from oxidation of CO in a process according to an embodiment of the invention; and

FIG. 2 is a flow chart of an isocyanate production method according to an embodiment of the invention incorporating an oxidation process according to the present invention.

### DETAILED DESCRIPTION OF THE INVENTION

As used herein, the singular terms “a” and “the” are synonymous and used interchangeably with “one or more.” Accordingly, for example, reference to “a gas” herein or in the appended claims can refer to a single gas or more than one gas. Additionally, all numerical values, unless otherwise specifically noted, are understood to be modified by the word “about.”

An initial gas containing hydrogen chloride and carbon monoxide that is suitable for use in the processes according to the invention can be the waste gas from a phosgenation reaction for the formation of organic isocyanates. Waste gases from chlorination reactions of hydrocarbons may however also be used.

A gas containing hydrogen chloride and carbon monoxide according to the invention may contain further oxidizable constituents, such as in particular hydrocarbons. These are generally oxidized along with carbon monoxide.

The content of hydrogen chloride in the gas containing hydrogen chloride and carbon monoxide entering a first reactor, in which the oxidation of the carbon monoxide can be carried out, can be, for example, 20 to 99.5 vol. %.

The content of carbon monoxide in the gas containing hydrogen chloride and carbon monoxide entering the first reactor can be, for example, 0.5 to 15 vol. %. a process according to the invention, when coupled with an isocyanate process, enables significantly higher amounts of carbon monoxide to be tolerated in the waste gas from a phosgenation reaction.

The oxidation of carbon monoxide and the possibly present further oxidizable constituents in a first reactor is expediently carried out by adding oxygen, oxygen-enriched air, or air. The addition of oxygen or oxygen-containing gas may take place stoichiometrically in reference to the carbon monoxide content or may be carried out with an excess of oxygen. Optionally, the temperature of the catalyst during the oxidation of the carbon monoxide as well as the outlet temperature of the intermediate gas can be controlled by adjusting the oxygen excess, as well as possibly by an optional addition of inert gas, preferably nitrogen.

The inflow temperature of the gas containing hydrogen chloride and carbon monoxide at the inlet to the first reactor is preferably 0° to 300° C., more preferably 0° to 150° C., even more preferably 0° to 100° C., and still more preferably 20° to 100° C.

Depending on the amount of heat generated during the oxidation of the carbon monoxide, the outflow temperature of the intermediate gas at the outlet of the first reactor is for example 100° to 600° C., preferably 150° to 400° C.

The mean operating temperature of the first reactor is in general about 50° to 400° C. These comparatively low temperatures permit a more economic operation under improved safety conditions.

An essential feature of the invention is that the oxidation of the carbon monoxide is carried out under adiabatic conditions. A first reactor in which the carbon monoxide oxidation can be carried out is operated adiabatically, i.e., heat is neither absorbed from the surroundings nor is heat released to the surroundings. Technically the adiabatic operation of the reactor can be accomplished by suitably insulating the reactor.

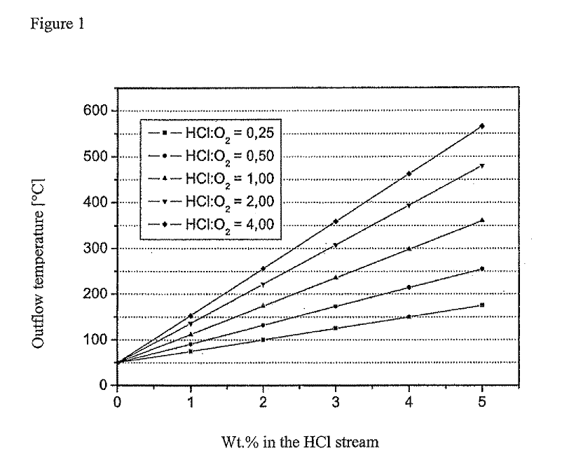

According to the invention, the heat of reaction that is released during oxidation of the carbon monoxide can therefore be used for the adiabatic heating of the feedstock materials so that they can be fed to an HCl oxidation phase without requiring extensive additional external heating. This effect can be calculated for various CO contents as well as various oxygen ratios and inflow temperatures based on reported thermodynamic values and known reaction equations. FIG. 1 graphically depicts outflow temperatures for various CO percentages in an initial gas, and oxygen ratios at an inflow temperature of 50° C.

More precise control of the course of the CO oxidation is possible over a temperature range up to the temperature that would cause a deactivation of the catalyst. Such control cannot take place with the hitherto known processes.

In the oxidation of carbon monoxide according to the invention at least one catalyst is preferably used that contains at least one compound containing an element selected from the group consisting of chromium, ruthenium, palladium, platinum, nickel, rhodium, iridium, gold, iron, copper, manganese, cobalt and zirconium. These elements may be used alone or in combination, and may be present in the form of their oxides. The catalysts may, if desired, also be supported.

Particularly preferred catalysts for the oxidation of carbon monoxide are those based on palladium, platinum, ruthenium, rhodium or iridium, with a promoter (e.g., nickel, manganese, copper, silver, lanthanum, etc.). Such catalyst systems are described, for example, in U.S. Pat. No. 4,639,432, the entire contents of which are incorporated herein by reference. Supported gold particles are also suitable for low temperature CO oxidation (T. Catal. 144, 175-192, 1993: Appl. Catal. A: General, 299, 266-273, 2006: Catal. Today, 112, 126-129, 2006), as well as cobalt compounds, e.g., in the form of cobalt spinels (Appl. Catal. A: General, 146, 255-267, 1996) or cobalt-containing or manganese-containing mixed oxide catalysts (see WO2004/103556). Cerium nanoparticles may also be used for the CO oxidation (Phys. Chem. Chem. Phys., 7, 2936-2941, 2005). The entire contents of each of the aforementioned references set forth in this paragraph are hereby incorporated herein by reference.

The oxidation of carbon monoxide is preferably carried out under those pressure conditions that correspond to the operating pressure of the HCl oxidation. Such operating pressures are, in general, 1 to 100 bar, preferably 1 to 50 bar, particularly preferably 1 to 25 bar. In order to compensate for a pressure drop in a catalyst bed, a slightly increased inflow pressure, with respect to the outflow pressure, can preferably be used.

The content of carbon monoxide in the first reactor is expediently reduced to less than 1 vol. %, preferably to less than 0.5 vol. % and still more preferably to less than 0.1 vol. %.

The gas exiting from the first reactor (i.e., the intermediate gas) generally contains HCl, CO₂, O₂ and further subsidiary constituents such as nitrogen. The unreacted oxygen may then be used in the further course of the process for the HCl oxidation.

The low CO content gas leaving the first reactor optionally passes over a heat exchanger into a second reactor for the oxidation of the hydrogen chloride. The heat exchanger between the first reactor and the second reactor is conveniently coupled to the first reactor via a temperature regulator. The temperature of the gas that is forwarded to the HCl oxidation during the further course of the process can be accurately adjusted with the heat exchanger. In this connection heat can be removed as necessary if the outflow temperature is too high, for example by generation of steam. If the outflow temperature is too low, the process gases can be brought to the desired temperature by a slight addition of heat. The added use of such a heat exchanger can help to compensate for fluctuations in the CO content and thus changes in the heating rate.

The oxidation of the hydrogen chloride with oxygen to form chlorine takes place in a manner known per se in a second reactor in the processes according to the invention. Such oxidation is described, for example, in WO04/014845, the entire contents of which are incorporated herein by reference.

Hydrogen chloride is oxidized with oxygen in an exothermic equilibrium reaction to form chlorine, steam also being produced. Normal reaction temperatures are 150° to 500° C., and normal reaction pressures are 1 to 50 bar. Since an equilibrium reaction is involved, it is expedient to operate at the lowest possible temperatures at which the catalyst is still sufficiently active.

Furthermore, it is advantageous to use oxygen in hyper-stoichiometric amounts. For example, a two-fold to four-fold oxygen excess is normally used. Since there is no danger of loss of selectivity, it may be economically advantageous to operate at relatively high pressures and accordingly with residence times that are longer compared to normal pressure. Suitable catalysts contain ruthenium oxide, ruthenium chloride or other ruthenium compounds on silicon dioxide, aluminium oxide, titanium dioxide or zirconium dioxide as support. Suitable catalysts may be obtained for example by application of ruthenium chloride to the support followed by drying, or drying and calcination. Suitable catalysts may furthermore contain chromium (III) oxide.

Conventional reaction apparatuses in which the catalytic hydrogen chloride oxidation can be carried out include fixed bed reactors and fluidized bed reactors. The microreactor technique is also a possible alternative. The hydrogen chloride oxidation may be carried out in several stages. The catalytic hydrogen chloride oxidation may likewise be carried out adiabatically, but preferably isothermally or approximately isothermally, batch-wise, preferably continuously as a fluidized bed or fixed bed process, preferably as a fixed bed process, particularly preferably in shell-and-tube reactors on heterogeneous catalysts at reactor temperatures from 180° to 500° C., preferably 200° to 400° C., particularly preferably 220° to 350° C. and at a pressure from 1 to 30 bar, preferably 1.2 to 25 bar, particularly preferably 1.5 to 22 bar and especially 2.0 to 21 bar.

In the isothermal or approximately isothermal procedure there may also be used a plurality, i.e., 2 to 10, preferably 2 to 6, particularly preferably 2 to 5 and especially 2 to 3, reactors connected in series with additional intermediate cooling. The oxygen may be added either wholly together with the hydrogen chloride upstream of the first reactor, or may be added distributed over the various reactors. This series arrangement of individual reactors may also be combined in one apparatus.

A preferred embodiment includes using a structured catalyst bed in which the catalyst activity increases in the flow direction. Such a structuring of the catalyst bed may be effected by varying impregnation of the catalyst supports with active material or by varying dilution of the catalyst with an inert material. As inert material there may for example be used rings, cylinders or spheres of titanium dioxide, zirconium dioxide or their mixtures, aluminium oxide, steatite, ceramics, glass, graphite or stainless steel. Suitable heterogeneous catalysts include in particular ruthenium compounds or copper compounds on support materials, which may also be doped; preferred are optionally doped ruthenium catalysts. Suitable support materials are for example silicon dioxide, graphite, titanium dioxide with a rutile or anatase structure, zirconium dioxide, aluminium oxide or their mixtures, preferably titanium dioxide, zirconium dioxide, aluminium oxide or their mixtures, particularly preferably γ or δ aluminium oxide or their mixtures. The copper and ruthenium supported catalysts may be obtained for example by impregnating the support material with aqueous solutions of CuCl₂ and RuCl₃ and optionally a promoter for the doping, preferably in the form of their chlorides.

The conversion of hydrogen chloride can be 15 to 95%, preferably 40 to 95%, and particularly preferably 50 to 90%. Unreacted hydrogen chloride can after separation be recycled in part or wholly to the catalytic hydrogen chloride oxidation. The catalytic hydrogen oxidation has, compared to the production of chlorine by electrolysis of hydrogen chloride, the advantage that no costly electrical energy is required, that no hydrogen in the form of a coupling product occurs, which is undesirable for safety reasons, and that the added hydrogen chloride need not be completely pure.

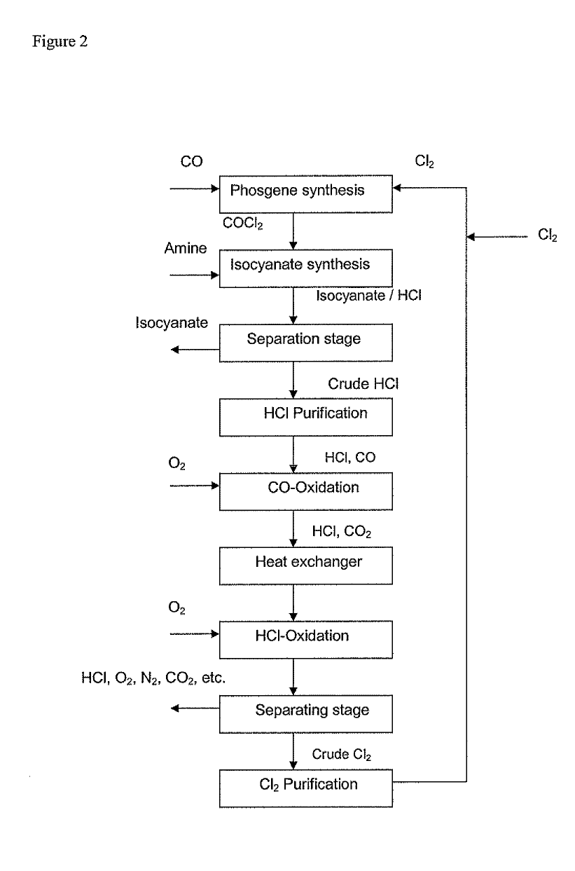

The heat of reaction of the catalytic hydrogen chloride oxidation may advantageously be utilized to generate high pressure steam. This can be used to operate the phosgenation reactor and the isocyanate distillation columns. The chlorine from the resulting chlorine-containing gas in step b) is separated in a manner known per se. Chlorine obtained by the processes according to the invention may then be reacted, according to processes known from the prior art with carbon monoxide to form phosgene, which can be used for the production of TDI or MDI from. TDA and MDA respectively. The hydrogen chloride which is in turn formed in the phosgenation of TDA and MDA may then be reacted according to the aforedescribed processes to form chlorine. FIG. 2 shows one embodiment of how the process according to the invention can be incorporated into the isocyanate synthesis, wherein a process according to the present invention is incorporated between a hydrogen chloride purification stage and a separating stage.

The carbon monoxide content in the HCl stream can be significantly reduced by a process according to the invention, whereby a deactivation of the Deacon catalyst at the next stage due to an uncontrolled rise in temperature is slowed down. At the same time the feed gas for the HCl oxidation is heated without a large external expenditure of energy to the operating temperature required for the HCl oxidation.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

What is claimed is:

1. A process comprising:
(a) providing an initial gas comprising hydrogen chloride and carbon monoxide;
(b) oxidizing in a first reactor the carbon monoxide in the presence of a catalyst to form an intermediate gas comprising hydrogen chloride and carbon dioxide under adiabatic conditions; and
(c) oxidizing in a second reactor the hydrogen chloride in the intermediate gas in the presence of a catalyst to form chlorine.

2. The process according to claim 1, wherein the initial gas further comprises additional oxidizable constituents.

3. The process according to claim 2, wherein the one or more additional oxidizable constituents comprises a hydrocarbon.

4. The process according to claim 1, wherein the oxidation of the carbon monoxide, the hydrogen chloride, or both is carried out with an oxidizer selected from the group consisting of oxygen, oxygen-enriched air, and air.

5. The process according to claim 1, wherein the initial gas comprising hydrogen chloride and carbon monoxide has an inflow temperature of 0° to 300° C. at an inlet of the first reactor.

6. The process according to claim 4, wherein the initial gas comprising hydrogen chloride and carbon monoxide has an inflow temperature of 0° to 300° C. at an inlet of the first reactor.

7. The process according to claim 1, wherein the initial gas comprising hydrogen chloride and carbon monoxide has an inflow temperature of 20° to 100° C. at an inlet of the first reactor.

8. The process according to claim 1, wherein the intermediate gas has an outflow temperature of 150° to 600° C. at an outlet of the first reactor.

9. The process according to claim 5, wherein the intermediate gas has an outflow temperature of 150° to 600° C. at an outlet of the first reactor.

10. The process according to claim 6, wherein the intermediate gas has an outflow temperature of 150° to 600° C. at an outlet of the first reactor.

11. The process according to claim 1, wherein a heat exchanger is connected between the first reactor and the second reactor.

12. The process according to claim 9, wherein a heat exchanger is connected between the first reactor and the second reactor.

13. The process according to claim 11, wherein the heat exchanger is coupled to the first reactor via a temperature regulator.

14. The process according to claim 8, wherein the outflow temperature of the intermediate gas is regulated by addition of an inert gas fraction.

15. The process according to claim 1, wherein hydrogen chloride is present in the initial gas in an amount of 20 to 99.5 vol. %.

16. The process according to claim 1, wherein carbon monoxide is present in the initial gas in an amount of 0.5 to 15 vol. %.

17. The process according to claim 1, wherein carbon monoxide is present in the intermediate gas in an amount of less than 1 vol. %.

18. The process according to claim 1, wherein carbon monoxide is present in the intermediate gas in an amount of less than 0.1 vol. %.

19. The process according to claim 1, wherein the catalyst for the oxidation of the carbon monoxide comprises at least one compound containing an element selected from the group consisting of chromium, ruthenium, palladium, platinum, nickel, rhodium, iridium, gold, iron, copper, manganese, cobalt and zirconium.

20. The process according to claim 1, wherein the catalyst for the oxidation of the hydrogen chloride comprises at least one compound containing an element selected from the group consisting of ruthenium, gold, palladium, platinum, osmium, iridium, silver, copper, potassium, rhenium and chromium.

21. The process according to claim 1, wherein the catalyst for the oxidation of the hydrogen chloride is arranged on a support material selected from the group consisting of silicon dioxide, aluminium oxide, titanium dioxide, zirconium dioxide, zeolite, tin oxide, and carbon nanotubes.

22. A process comprising:
(a) reacting carbon monoxide in stoichiometric excess with chlorine in the presence of a catalyst to form phosgene;
(b) reacting the phosgene with an organic amine to form an organic isocyanate and a gas comprising hydrogen chloride and carbon monoxide;
(c) separating the organic isocyanate from the gas;
(d) oxidizing the carbon monoxide in the presence of a catalyst under adiabatic conditions to form an intermediate gas comprising hydrogen chloride and carbon dioxide; and
(e) oxidizing the hydrogen chloride to catalytic in the intermediate gas in the presence of a catalyst to form chlorine.

23. The process according to claim 22, wherein the reaction of the phosgene with the organic amine is carried out in gas phase.
